(19) United States
(12) Patent Application Publication
(10) Pub. No.: US 2024/0129482 A1
(43) Pub. Date: Apr. 18, 2024

(54) VIDEO ENCODING DEVICE, VIDEO DECODING DEVICE, AND VIDEO ENCODING METHOD

(71) Applicant: NEC Corporation, Tokyo (JP)

(72) Inventors: Kenta IIDA, Tokyo (JP); Kenta TOKUMITSU, Tokyo (JP); Tatsuji MORIYOSHI, Tokyo (JP); Keiichi CHONO, Tokyo (JP)

(73) Assignee: NEC Corporation, Tokyo (JP)

(21) Appl. No.: 18/483,984

(22) Filed: Oct. 10, 2023

(30) Foreign Application Priority Data
Oct. 18, 2022 (JP) 2022-166819

(51) Int. Cl. H04N 19/139; H04N 19/132; H04N 19/176

(52) U.S. Cl. CPC H04N 19/139; H04N 19/132; H04N 19/176

(57) ABSTRACT

The video coding device is a video coding device capable of executing a predictive coding process including a specific process in which a coded frame of a different resolution from a resolution of a frame to be processed is used as a reference frame, and includes a coding unit which executes the predictive coding process, and a controller which prohibits, in the predictive coding process, execution of a first process which uses information, which is determined based on a spatial position of the block to be coded, on blocks in frames at different times, a second process which performs correction using information computed when decoding is performed, or both the first process and the second process.

This application is based upon and claims the benefit of priority from the prior Japanese Patent Application 2022-166819, filed on Oct. 18, 2022, the entire contents of which are incorporated herein by reference.

### BACKGROUND OF THE INVENTION

### Field of the Invention

This invention relates to a video encoding device, video decoding device, and video encoding method capable of coding and decoding video based on inter prediction.

### Description of the Related Art

A video encoding device codes video frames at each time of a video signal to generate a video bitstream. For example, a video encoding device performs a coding process based on H264/AVC (Advanced Video Coding) standard, H.265/HEVC (High Efficiency Video Coding) standard, H.266/VVC (Versatile Video Coding) standard (hereinafter referred to as the VVC standard), or the like.

The frame to be processed is partitioned into blocks. The coding process is applied to each block. The encoding methods include an intra-prediction coding method and an inter-prediction coding method. The intra-prediction is a predictive coding method that is performed by referring to an area in the frame to be processed. The inter-prediction is a predictive coding method that codes the frame to be processed by referring to an area of the frame that has already been coded.

The VVC standard provides various coding tools (hereinafter referred to as tools) are provided. The tool is a coding technique for the purpose of improving coding efficiency, etc (for example, refer to Non-patent literature 1).

RPR (Reference Picture Resampling) is one of the tools in the VVC standard. When performing coding using the inter-prediction method, RPR allows to refer to a coded frame of a different resolution (size) than that of the frame to be processed if a predetermined condition is met. Specifically, when a size of the frame to be processed is different from a size of the coded frame to be referenced, the video encoding device codes the frame by referring to a resized frame of the coded frame. Hereinafter, a video encoding device is sometimes referred to as an encoder.

When coding a frame to be processed by referring to a coded frame with a different resolution, the inability to use RPR causes a restriction in the coding process. For example, when a frame of a different size from another frame that will be a reference frame appears in a video comprising a series of frames, the encoder needs to perform a termination process once and encode the frame of a different size as an I (intra coded) frame. That is because if RPR cannot be used, coding methods based on inter-prediction cannot be selected and the encoder cannot use a P (Predictive) frame or a B (Bi-directional predicted). When frames of different sizes appear frequently, for example, when frames are frequently resized, the encoder needs to perform frequent termination process. This may reduce coding efficiency.

When RPR is available, resolution switching can be performed without the above restriction. In the VVC standard, there are tools whose use is prohibited when RPR is applied. Hereinafter, the tools that are prohibited for use are referred to as specific tools.
[Non patent literature 1] Recommendation ITU-T H.266 “Versatile video coding”, Telecommunication Standardization Sector of the ITU, August 2020
[Non patent literature 2] ARIB Standard STD-B32 Version 3.3, “Video Coding, Audio Coding, and Multiplexing Specifications for Digital Broadcasting”, Association of Radio Industries and Businesses, Jul. 3, 2015

### SUMMARY OF THE INVENTION

Hereinafter, a video decoding device is sometimes referred to as a decoder. When an encoder and a decoder are devices conforming to a common scheme, the encoder must be guaranteed to always generate a stream that can be correctly decoded by the decoder. If the decoder cannot correctly decode only the stream generated by the encoder under a certain condition, then interoperability is degraded. To avoid degrading interoperability under various conditions, encoder development requires exhaustive verification aimed at guaranteeing that the decoder can always decode correctly.

For encoder processing, there are cases in which the use of a certain coding tool requires restrictions on other coding tools, such as prohibiting the use of a predetermined tool. In this case, when the coding process is executed without applying constraints, a stream that cannot be decoded at the decoder side will be generated. In other words, interconnectivity between the encoder and the decoder is degraded.

In particular, when switching between use enable and use disable for the tool that constrains other tools is frequently occurs, this can easily lead to a state of reduced interoperability. This also increases the number of conditions to be covered during verification, which increases the time required for verification.

It is an object of the present invention to prevent degradation of interconnectivity between a video encoding device and a video decoding device while suppressing the time required for verification.

A preferred aspect of the video encoding device capable of executing a predictive coding process including a specific process in which a coded frame of a different resolution from a resolution of a frame to be processed is used as a reference frame, includes a coding unit which executes the predictive coding process, and a controller which prohibits, in the predictive coding process, execution of a first process which uses information, which is determined based on a spatial position of the block to be coded, on blocks in frames at different times, a second process which performs correction using information computed when decoding is performed, or both the first process and the second process.

A preferred aspect of the video decoding device which performs a predictive decoding process, includes a decoding unit which performs decoding on generated coded data under the condition that execution of a first process which uses information, which is determined based on a spatial position of the block to be coded, on blocks in frames at different times, a second process which performs correction using information computed when decoding is performed, or both the first process and the second process is prohibited in a predictive coding process.

A preferred aspect of the video encoding method for executing a predictive coding process including a specific process in which a coded frame of a different resolution from a resolution of a frame to be processed is used as a reference frame, includes prohibiting, in the predictive coding process, execution of a first process which uses information, which is determined based on a spatial position of the block to be coded, on blocks in frames at different times, a second process which performs correction using information computed when decoding is performed, or both the first process and the second process.

A preferred aspect of the video decoding method for executing a predictive decoding process, includes a decoding unit which performs decoding on generated coded data under the condition that execution of a first process which uses information, which is determined based on a spatial position of the block to be coded, on blocks in frames at different times, a second process which performs correction using information computed when decoding is performed, or both the first process and the second process is prohibited in a predictive coding process.

The video system according to the present invention includes the video encoding device described above and the video decoding device described above.

A preferred aspect of the video coding program for causing a computer to execute a predictive coding process including a specific process in which a coded frame of a different resolution from a resolution of a frame to be processed is used as a reference frame, causes the computer to prohibit, in the predictive coding process, execution of a first process which uses information, which is determined based on a spatial position of the block to be coded, on blocks in frames at different times, a second process which performs correction using information computed when decoding is performed, or both the first process and the second process.

A preferred aspect of the video decoding program for causing a computer to execute a predictive decoding process, causes the computer to decode on generated coded data under the condition that execution of a first process which uses information, which is determined based on a spatial position of the block to be coded, on blocks in frames at different times, a second process which performs correction using information computed when decoding is performed, or both the first process and the second process is prohibited in a predictive coding process.

According to the present invention, the interconnectivity between a video encoding device and a video decoding device can be prevented from degrading while the time required for verification is suppressed. It also has the effect of enabling omission of implementation of a processing section necessary for processing tool subject to prohibition in the video encoding device and video decoding device.

### BRIEF DESCRIPTION OF THE DRAWINGS

FIG. 1 It depicts an explanatory diagram showing a prohibited tool on use.

FIG. 2 It depicts a block diagram showing a configuration example of the video encoding device.

FIG. 3 It depicts a flowchart showing an example of the operation of the coding controller.

FIG. 4 It depicts an explanatory diagram showing an example of the processing of a video encoding device.

FIG. 5 It depicts a block diagram showing a configuration example of the video decoding device.

FIG. 6 It depicts a flowchart showing an example of the operation of the video decoder.

FIG. 7 It depicts an explanatory diagram showing an example of a picture structure.

FIG. 8 It depicts an explanatory diagram for explaining an effect of the example embodiment.

FIG. 9 It depicts an explanatory diagram for explaining an effect of the example embodiment.

FIG. 10 It depicts a block diagram showing a configuration example of the video system.

FIG. 11 It depicts a block diagram showing a configuration example of the information processing system.

FIG. 12 It depicts a block diagram showing the main part of the video encoding device.

FIG. 13 It depicts a block diagram showing the main part of the video decoding device.

### DESCRIPTION OF THE PREFERRED EMBODIMENTS

Hereinafter, example embodiments of the present invention will be explained with reference to the drawings.

### [Precondition]

In the VVC standard, “sps_refpic_resampling_enabled_flag” and “sps_res_change_in_clvs_allowed_flag” must have valid values (=1) in order to use RPR. When these values are valid, whether or not RPR is applied to each frame is automatically determined based on information in the “Picture Parameter Set (PPS)” of a frame to be processed and a coded frame, and the information is held in the parameter of “RprConstraintsActiveFlag”. For example, when the value of pps_pic_width_in_luma_samples corresponding to the frame to be processed does not match the value of pps_pic_widthin_luma_samples corresponding to the frame to be processed, the value of “RprConstraintsActiveFlag” is a value indicating that RPR is applied (=1).

When RPR is applied, the use of specific tools is prohibited. Specifically, specific tools are TMVP (Temporal Motion Vector Prediction), SbTMVP (Subblock-based Temporal Motion Vector Prediction), DMVR (Decoder side Motion Vector Refinement), BDOF (Bi-directional Optical Flow), and PROF (Prediction Refinement with Optical Flow).

TMVP is a tool that derives motion vectors using a temporal direction prediction. Specifically, a motion vector is derived using information determined based on a spatial position of the block to be coded in a reference frame which is a frame at a different time. The block to be coded is a block in the frame to be processed.

In the VVC standard, for the derivation of TMVP motion vectors, when the upper left coordinate of the block to be coded, whose width and height are W and H, is (x, y), the information of the block corresponding to a position of (((x+W)>>3)<<3, (y+H)>>3)<<3) in a reference frame which is a frame of different time, or a position of (((x+W>>1)>>3)<<3, (y+H>>1)>>3)<<3) is referenced. A coordinate space is assumed in which the origin is the upper left corner of the frame, and the horizontal and vertical axes are positive to the right and down. The “a>>n” and “a<<n” denote n bits to the right and left, respectively, for a given value of a.

SbTMVP is the TMVP in a subblock unit. For example, suppose that the upper left coordinate of the block to be coded whose width and height are W and H is (x, y), and the block is partitioned into P×Q sub-blocks whose width and height are 8 respectively. p-th and q-th sub-blocks are assumed. It should be noted that 0<p<P and 0<q<Q. For the subblock, based on the reference of the block at (((x+px8+4+dx)>>3)<<3, ((y+qx8+4+dy)>>3)<<3) in the reference frame, the motion vectors are derived. dx and dy indicate a horizontal displacement and a vertical displacement of the motion vector derived by TMVP in the block to be coded.

DMVR is a tool to correct motion vectors on the decoder side in the skip mode and the merge mode. Specifically, in the decoder side, the tool shifts one of the reference blocks in the two coded frames specified by the bi-directional prediction within a predetermined pixel range to search for the position with the smallest SAD (Sum of Absolute Difference) value, and corrects the motion vector using the obtained shift value. In other words, DMVR is a tool that performs correction using calculated information during decoding.

BDOF is a tool that corrects the predicted image in the decoder side by deriving an optical flow from a time variation of luminance values and spatial gradient values for each pixel using two images generated by the bi-directional prediction, and converting the optical flow into a correction value in the block to be coded to correct the predicted image. Thus, it is a tool that performs correction using the calculated information during decoding.

PROF is a tool that calculates a prediction value of the luminance signal by deriving a correction for the prediction value obtained by the affine motion compensation and adding the correction, when the affine prediction is used in sub-block mode. Thus, PROF is a tool that performs correction using the calculated information during decoding.

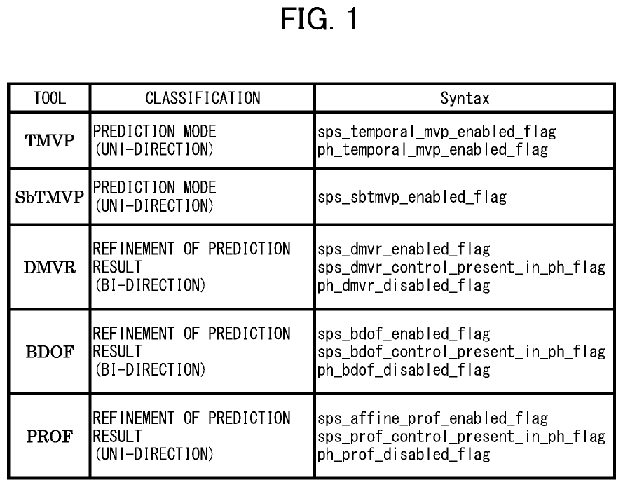

FIG. 1 is a table showing prohibited tools for RPR use and syntaxes that control enable/disable of each tool in the VVC standard. Syntaxes beginning with “sps” are those that control enable/disable of each tool in a sequence unit. Syntaxes beginning with “ph” are syntaxes that control enable/disable in a picture unit. “*_control_present_in_ph_flag” is a tool to prohibit tool control in a picture. It should be noted that “*” means a wild card. “Refinement” in FIG. 1 means correcting. Using these syntaxes, it is possible to disable the use of prohibited tools when coding is performed.

### Example Embodiment

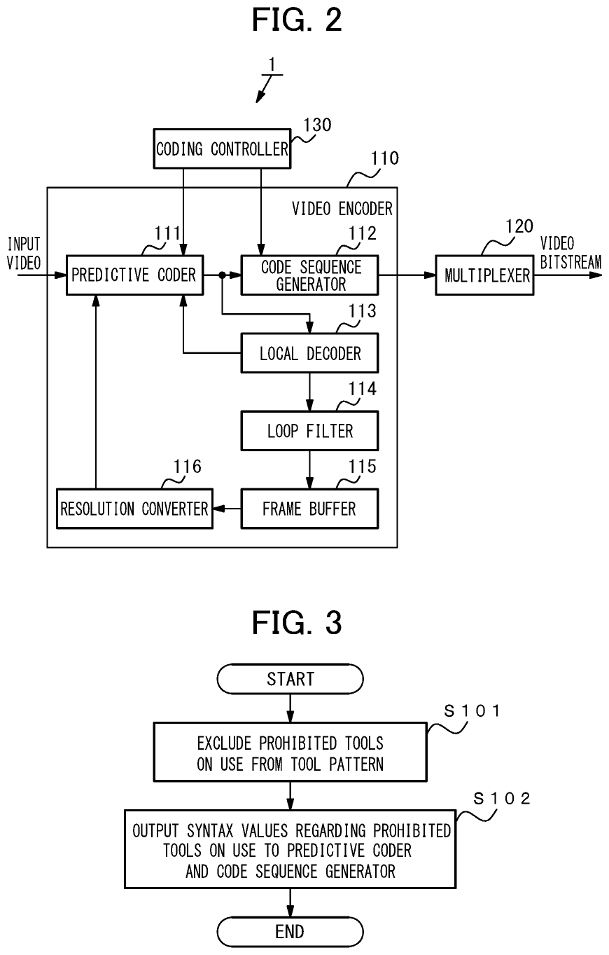

FIG. 2 is a block diagram showing an example configuration of the video encoding device. The video encoding device 1 shown in FIG. 2 comprises a video encoder 110, a multiplexer 120, and a coding controller 130. The video encoder 110 includes a predictive coder 111, a code sequence generator 112, a local decoder 113, a loop filter 114, a frame buffer 115, and a resolution converter 116. The video encoding device 1 can use RPR. The arrows in FIG. 2 indicate the direction of signal (data) flow in a straightforward manner, but do not exclude bidirectionality. This is also true for other block diagrams.

The predictive coder 111 performs the predictive coding process using intra or inter prediction for each picture comprising the input video. In the predictive coding process, the predictive coder 111 quantizes the frequency-transformed prediction error image (frequency transform coefficient). The quantized frequency transform coefficient is a transform quantization value. The local decoder 113 generates a reconstructed image from the prediction error image which is restored by applying inverse quantization and inverse transformation to the transform quantization value, and the prediction image generated by the predictive coder 111. The loop filter 114 filters the reconstructed signal and stores it in the frame buffer 115. The resolution converter 116 functions to apply a resizing process to the reconstructed image if the size of the buffered reconstructed image and the size of the input image differ when performing inter-prediction. The predictive encoder 111 supplies the transform quantization value to the code sequence generator 112.

The code sequence generator 112 entropy-encodes the prediction parameters and the transform quantization value. The prediction parameters are information related to prediction, such as a prediction mode (intra prediction, inter prediction), an intra prediction block size, an intra prediction direction, an inter prediction block size, and a motion vector. The prediction parameters include various syntax values. The code sequence generator 112 outputs the entropy-coded transform quantization values and the prediction parameters to the multiplexer 120. The prediction parameters may be supplied to the multiplexer 120 from the coding controller 130.

The multiplexer 120 multiplexes the coded transform quantization values and the prediction parameters, and outputs them as a video bitstream. For example, the video bitstream is transmitted to a video decoding device.

The coding controller 130 performs processes such as determining prediction parameters, etc. The coding controller 130 outputs the prediction parameters to the predictive coder 111 and the code sequence generator 112.

Next, the operation of the coding controller 130 will be explained. FIG. 3 is a flowchart showing an example of the operation of the coding controller 130. FIG. 3 shows control over RPR.

The video encoding device 1 is a device capable of using RPR. The video encoding device 1 need not have a mechanism to perform TMVP, SbTMVP, DMVR, BDOF, and PROF.

Such a mechanism can be realized, for example, by software. When the video encoding device 1 is configured as such, the size (for example, program size) of the video encoding device 1 can be reduced because there are fewer specific tools to be implemented.

The coding controller 130 controls to prohibit the use of specific tools (prohibited tools on use) regardless of whether RPR is applied or not (step S101). Specifically, the coding controller 130 performs a process of setting values of the following syntax elements.

To prohibit the use of TMVP, set sps_temporal_mvp_enabled_flag=0 and ph_temporal_mvp_enabled_flag=0.

To prohibit the use of SbTMVP, set sps_sbtmvp_enabled_flag=0.

To prohibit the use of DMVR, set sps_dmvr_enabled_flag=0 and sps_dmvr_control_present_in_ph_flag=0.

To prohibit the use of BDOF, set sps_bdof_enabled_flag=0 and sps_bdof_control_present_in_ph_flag=0. To prohibit the use of PROF, set sps_affine_prof_enabled_flag=0 and sps_prof_control_present_in_ph_flag=0.

In the process of step S101, the coding controller 130, for example, excludes the specific tools from a table of tool patterns for which the usable tools are set. The coding controller 130 may switch from using a tool pattern for which a specific tool is also set to using a tool pattern for which no specific tool is set.

The coding controller 130 outputs the set syntax element values to the predictive coder 111 and the code sequence generator 112 (step S102).

Thereafter, the predictive coder 111 performs the coding process for the frame to be processed without using the specific tools that are prohibited on use in the predictive coding process.

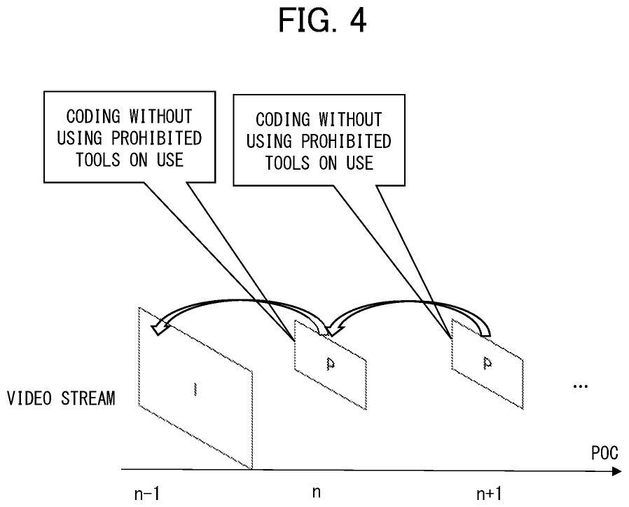

FIG. 4 is an explanatory diagram showing an example of the processing of a video encoding device. In the example shown in FIG. 4, the frame with a Picture Order Count (POC) of n is a frame to be processed. The frame with a POC of (n−1) is a high-resolution video frame. The frame with a POC of n is a low-resolution video frame. In this example embodiment, regardless of whether RPR is applied or not, the coding is performed without using specific tools (prohibited tools on use).

The example shown in FIG. 4 is used, for example, to suppress a code amount by reducing the resolution before coding, when frames with a POC of n and a POC of (n+1) are frames with high coding difficulty, i.e., when an amount of code to be generated is more than a predetermined value.

In this example embodiment, since the video encoding device 1 which can use RPR does not always perform processing using the specified tools when the RPR is applied, interoperability between the video encoding device 1 and the video decoding device that receives the video bitstream transmitted by the video encoding device 1 is not degraded. In other words, even if a general video decoding device capable of using RPR is used in the video system, the video decoding device will not become unable to decode the received video bitstream due to the use of specific tools when RPR is applied.

### [Modification 1]

In the above example embodiment, when RPR is applied, the coding controller 130 controls to prohibit execution of a first process (for example, a process using TMVP or SbTMVP) which uses information on blocks in frames at different times determined based on the spatial position of the block to be coded, and execution of a second process (for example, a process using DMVR, BDOF, or PROF) which performs correction using information computed when decoding is performed.

However, the coding controller 130 may also be controlled such that execution of some of the first and second processes is prohibited. For example, the video encoding device 1 may be configured such that only some of TMVP, SbTMVP, DMVR, BDOF, and PROF (some specific tools) can be executed. In other words, when the coding controller 130 determines that RPR is disabled, the coding controller 130 controls to prohibit the use of tools other than those that are considered usable. When RPR is enabled, the coding controller 130 prohibits execution of the first and second processes.

When the video encoding device 1 is configured as such, although the number of specific tools to be implemented increases compared to the above example embodiment, the size of the video encoding device 1 (for example, program size) can be reduced because it can be reduced compared to the case where the present invention is not applied.

In the modification 1, in order to guarantee that processing using specific tools is not executed when RPR is applied, the coding controller 130 controls to prohibit the use of specific tools that are supposed to be available when the resolution of the frame to be processed is changed.

In the above example embodiment, the use of all specific tools is prohibited at all times. As a result, there is no need to control to prohibit the use of specific tools every time the frame size is switched. On the other hand, coding efficiency is reduced. However, in the modification 1, since some of the specified tools can be used in situations other than when the use of the specified tools is prohibited, the decrease in coding efficiency is suppressed.

### [Modification 2]

When RPR is applied, the coding controller 130 may set the “sps_*_enabled_flag” syntax value for TMVP, SbTMVP, DMVR, BDOF and PROF to 1 and the “ph_*_enabled_flag” syntax value to 0. In other words, instead of prohibiting the use of a specific tool in a sequence unit, the use of a specific tool is prohibited in a picture unit to achieve the same processing as in the example embodiment.

Even in the modification 2, it can be said that some of the specific tools can be used when RPR is applied.

In the modification 2, in order to guarantee that processing using specific tools is not executed when RPR is applied, the coding controller 130 controls to prohibit the use of specific tools that are supposed to be available when the resolution of the frame to be processed is changed.

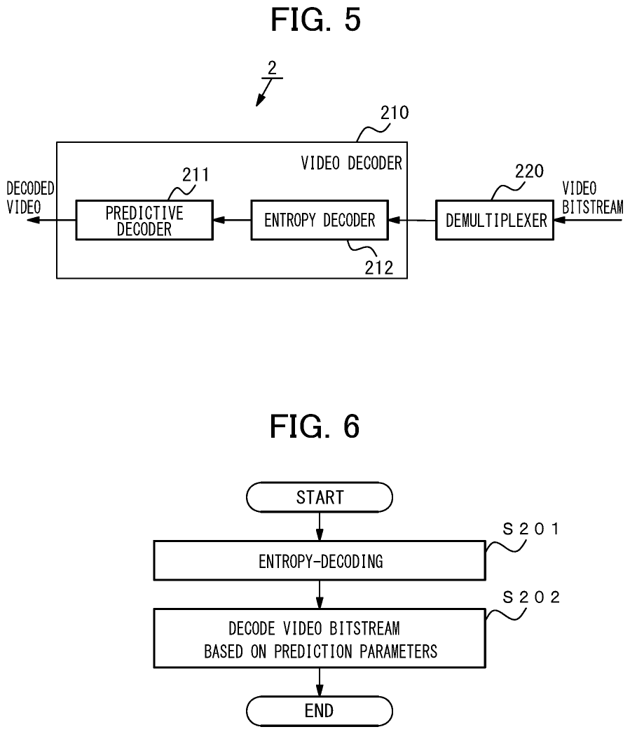

FIG. 5 is a block diagram showing a configuration example of the video decoding device. The video decoding device 2 shown in FIG. 5 comprises a demultiplexer 220 and a video decoder 210. The video decoder 210 includes an entropy decoder 212 and a predictive decoder 211.

The demultiplexer 220 demultiplexer the video bitstream transmitted from the video encoding device to extract an entropy-coded video bitstream. The video bitstream includes the coded data, i.e., the coded transform quantization values and the prediction parameters.

The entropy decoder 212 entropy-decodes the video bit bitstream. The predictive decoder 211 generates the reconstructed image. The predictive decoder 211 outputs a reconstructed image as a decoded video.

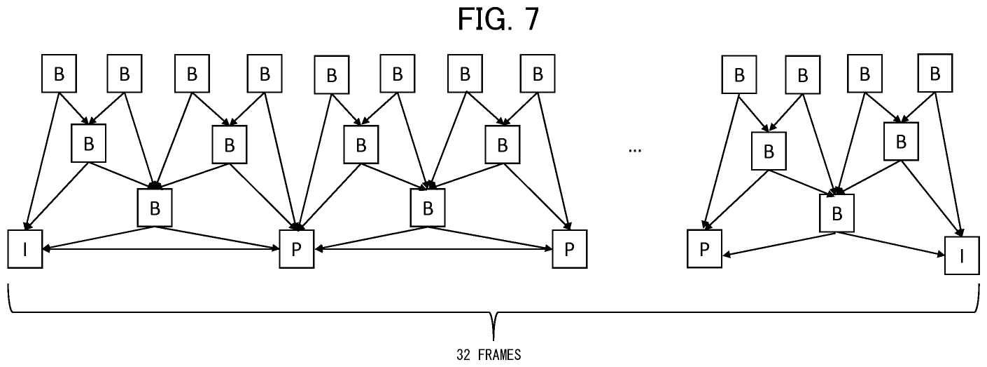

Next, the operation of the video decoder 210 will be explained. FIG. 6 is a flowchart showing an example of the operation of the video decoder 210.

The entropy decoder 212 entropy-decodes the entropy-coded video bitstream (step S201). The entropy-decoded video bitstream is input to the predictive decoder 211.

The predictive decoder 211 performs decoding processing on the entropy-decoded video bitstream (step S202). In step S202, the predictive decoder 211 performs predictive decoding on the video bitstream to generate a prediction signal. The predictive decoder 211 generates a reconstructed image using the prediction signal.

As described above, it is guaranteed that the video encoding device 1 that can use RPR does not perform processing using the specific tools when RPR is applied. Therefore, the video decoding device 2 will not become unable to decode the video bitstream received from the video coding device 1 due to the use of a specific tool when RPR is applied. The video bitstream received from the video encoding device 1 includes coded data generated in the predictive coding process under the condition that execution of the first process which uses information on blocks in frames at different times determined based on the spatial position of the block to be coded, execution of the second process which performs correction using information computed when decoding is performed, or execution of both the first process and the second process is prohibited.

Next, effects other than those described above will be explained.

FIG. 7 shows an example of SOP (Structure of Pictures) which is a picture structure introduced in Non-patent literature 2. The SOP is a unit describing the coding order and reference relationship of each AU (Access Unit) in the case of performing temporal scalable coding. The temporal scalable coding is such coding that enables a frame to be extracted partially from video of a plurality of frames. One GOP (Group of Pictures) comprises one or more SOPs. In FIG. 7, the horizontal axis indicates a display order and the vertical axis indicates a layer. The layers include layer 0, layer 1, layer 2 and layer 3.

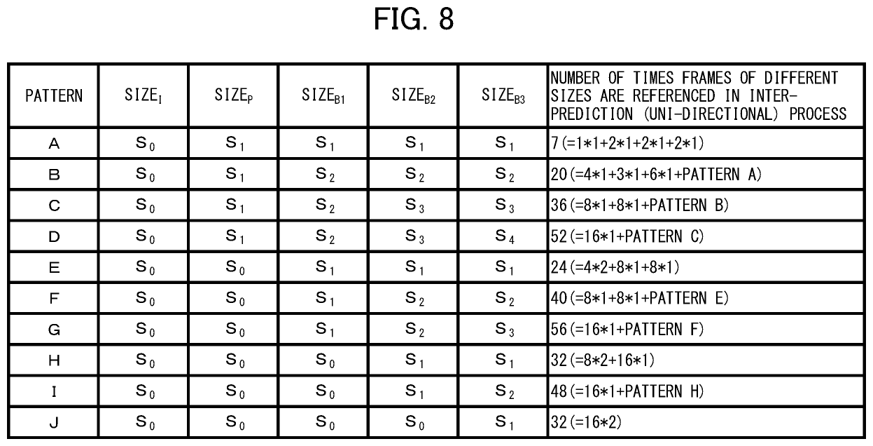

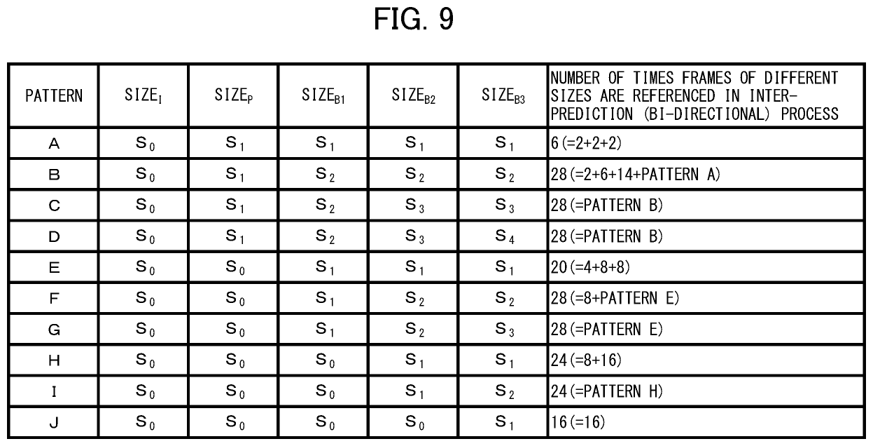

FIG. 8 is an explanatory diagram showing the number of times frames of different sizes are referenced when uni-directional inter-prediction is performed using the picture structure shown in FIG. 7. FIG. 9 is an explanatory diagram showing the number of times different size images are referenced when bi-directional inter-prediction is performed using the picture structure shown in FIG. 7. It is assumed that the frame size is determined for each slice type.

In FIGS. 8 and 9, S₀-S₄ denote an image size (a frame size), respectively. That is, the set of sizes S∈{S₀, S₁, S₂, S₃, S₄} and also S₀≠S₁≠S₂≠S₃≠S₄.

In FIGS. 8 and 9, “I” in x of SIZEx (x=I, P, B1, B2, B3) corresponds to an I frame. “P” corresponds to a P frame. “B1” corresponds to a B frame of layer 1. “B2” corresponds to a B frame of layer 2. “B3” corresponds to a B-frame of layer 3.

The rightmost column in FIG. 8 and the rightmost column in FIG. 9 show the number of times images of different sizes are referenced. As shown in FIG. 8, when uni-directional inter-prediction is performed, the total number of references is 347. Therefore, the prediction process occurs [347×CU (coding unit) to be searched] times. As shown in FIG. 9, when bi-directional inter-prediction is performed, the total number of references is 230. Therefore, the prediction process occurs [total 230×CU to be searched] times.

For a video encoding device that can use RPR and to which the above example embodiment is not applied, it is necessary to verify whether the restrictions on RPR (no use of TMVP, SbTMVP, DMVR, BDOF and PROF) are kept. A video decoding device also needs to be verified.

However, in the video encoding device of the above example embodiment, since it is guaranteed that no processing using specific tools is performed when RPR is applied, there is no need to verify whether or not the restrictions regarding RPR are kept. In other words, the video encoding device of the above example embodiment reduces the time required for device verification.

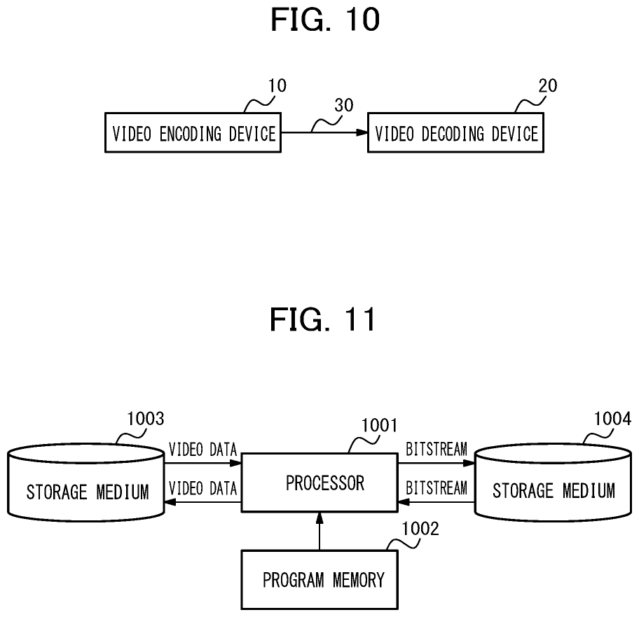

FIG. 10 is a block diagram showing an example configuration of the video system. The video system shown in FIG. 10 is a system in which a video encoding device 10 (corresponding to the video encoding device 1 of the first example embodiment) and a video decoding device 20 (corresponding to the video decoding device 2 of the first example embodiment) are connected by a transmission path (wireless transmission path or wired transmission path) 30.

In the video system, the video encoding device 10 can generate a video bitstream having a feature explained in the above example embodiment. In addition, in the video system, the video decoding device 20 can decode a video bitstream having a feature explained in the above example embodiment.

The above example embodiment can be configured in hardware, but they can also be realized by a computer program.

The information processing system shown in FIG. 11 includes a processor 1001 such as a CPU (Central Processing Unit), a program memory 1002, a storage medium 1003 for storing video data, and a storage medium 1004 for storing a bitstream. The storage medium 1003 and the storage medium 1004 may be separate storage media, or storage areas included in the same storage medium. A magnetic storage medium such as a hard disk can be used as the storage medium.

In the information processing system, the program memory 1002 stores a program (a video encoding programs or a video decoding program) to realize the functions of each block indicated in the above example embodiment.

The processor 1001 realizes the functions of the video encoder 110, the multiplexer 120, the coding controller 130, the video decoder 210, and the demultiplexer 220 shown in the above example embodiment by executing the processes according to the program stored in the program memory 1002.

For example, the functions of the video encoding device 1 are realized by the processor 1001 executing the processing according to the video coding program to realize the functions of each block in the video encoding device 1 shown in FIG. 2. Further, for example, the functions of the video decoding device 2 are realized by the processor 1001 executing the processing according to the video decoding program to realize the functions of each block in the video decoding device 2 shown in FIG. 5.

At least the program memory 1002 is a non-transitory computer readable media. However, the program may be stored in various types of transitory computer readable media. The transitory computer readable medium is supplied with the program through, for example, a wired or wireless communication channel, i.e., through electric signals, optical signals, or electromagnetic waves.

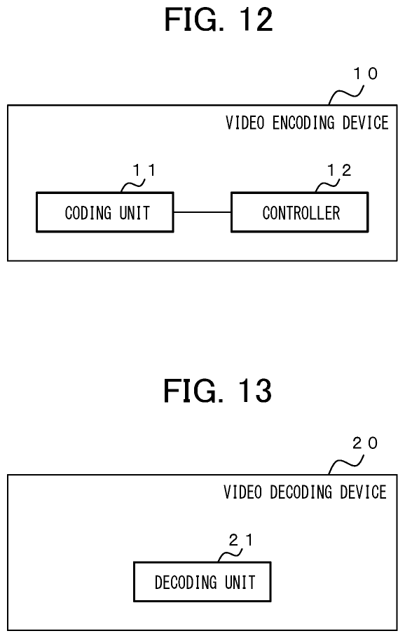

FIG. 12 is a block diagram showing the main part of the video encoding device. The video encoding device 10 is a video encoding device capable of executing a predictive coding process including a specific process (for example, a process based on RPR) in which a coded frame of a different resolution from a resolution of a frame to be processed is used as a reference frame, comprises a coding unit (coding means) 11 (in the example embodiment, realized by the predictive coder 111) which executes the predictive coding process, and a controller (control means) 12 (in the example embodiment, realized by the coding controller 130) which prohibits, in the predictive coding process, execution of a first process (for example, a process using TMVP, a process using SbTMVP) which uses information on blocks in frames at different times determined based on a spatial position of the block to be coded, a second process (for example, a process using DMVR, a process using BDOF, a process using PROF) which performs correction using information computed when decoding is performed, or both the first process and the second process. The controller 12 may always prohibits the first process, the second process, or both the first process and the second process regardless of the resolution of the frame to be processed and the resolution of the frame that has already been coded.

FIG. 13 is a block diagram showing the main part of a video decoding device. The video decoding device 20 is a video decoding device which a predictive decoding process, comprises a decoding unit (decoding means) 21 (in the example embodiment, realized by the predictive decoder 211) which performs decoding on generated coded data under the condition that execution of a first process which uses information on blocks in frames at different times determined based on a spatial position of the block to be coded, a second process which performs correction using information computed when decoding is performed, or both the first process and the second process is prohibited in a predictive coding process.

1. A video encoding device capable of executing a predictive coding process including a specific process in which a coded frame of a different resolution from a resolution of a frame to be processed is used as a reference frame, comprising,
a memory storing software instructions and,
one or more processors configured to execute the software instructions to:
execute the predictive coding process, and
prohibit, in the predictive coding process, execution of a first process which uses information, which is determined based on a spatial position of the block to be coded, on blocks in frames at different times, a second process which performs correction using information computed when decoding is performed, or both the first process and the second process.

2. The video encoding device according to claim 1,
wherein
the first process includes multiple types of processes,
the second process includes multiple types of processes, and
the one or more processors configured to execute the software instructions to prohibit the execution of all processes included in the first process and all processes included in the second process.

3. The video encoding device according to claim 1,
wherein
the first process includes multiple types of processes,
the second process includes multiple types of processes, and
the one or more processors configured to execute the software instructions to prohibit the execution of some of all processes included in the first process and the second process.

4. The video encoding device according to claim 2, executing the predictive coding process based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).

5. The video encoding device according to claim 3, executing the predictive coding process based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).

6. A video decoding device which performs a predictive decoding process, comprising,
a memory storing software instructions and,
one or more processors configured to execute the software instructions to:
perform decoding on generated coded data under the condition that execution of a first process which uses information, which is determined based on a spatial position of the block to be coded, on blocks in frames at different times, a second process which performs correction using information computed when decoding is performed, or both the first process and the second process is prohibited in a predictive coding process.

7. The video decoding device according to claim 6,
wherein
the first process includes multiple types of processes,
the second process includes multiple types of processes, and
the one or more processors configured to execute the software instructions to perform decoding on generated coded data under the condition that the execution of all processes included in the first process and all processes included in the second process.

8. The video decoding device according to claim 6,
wherein
the first process includes multiple types of processes,
the second process includes multiple types of processes, and
the one or more processors configured to execute the software instructions to perform decoding on generated coded data under the condition that the execution of some of all processes included in the first process and the second process.

9. The video decoding device according to claim 7, decoding coded data by a predictive coding process including a specific process in which a coded frame of a different resolution from a resolution of a frame to be processed is used as a reference frame, and based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).

10. The video decoding device according to claim 8, decoding coded data by a predictive coding process including a specific process in which a coded frame of a different resolution from a resolution of a frame to be processed is used as a reference frame, and based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).

11. A video encoding method for executing a predictive coding process including a specific process in which a coded frame of a different resolution from a resolution of a frame to be processed is used as a reference frame, comprising:
prohibiting, in the predictive coding process, execution of a first process which uses information, which is determined based on a spatial position of the block to be coded, on blocks in frames at different times, a second process which performs correction using information computed when decoding is performed, or both the first process and the second process.

12. The encoding method according to claim 11,
wherein
the first process includes multiple types of processes,
the second process includes multiple types of processes, and
the execution of all processes included in the first process and all processes included in the second process is prohibited.

13. The encoding method according to claim 11,
wherein
the first process includes multiple types of processes,
the second process includes multiple types of processes, and
the execution of some of all processes included in the first process and the second process is prohibited.

14. The video encoding method according to claim 12, executing the predictive coding process based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).

15. The video encoding method according to claim 13, executing the predictive coding process based on VVC (Versatile Video Coding) standard,
wherein
the specific process is a coding process using RPR (Reference Picture Resampling),
the processes included in the first process are a process using TMVP (Temporal Motion Vector Prediction) and a process using SbTMVP (Subblock-based Temporal Motion Vector Prediction), and
the processes included in the second processing are a process using DMVR (Decoder side Motion Vector Refinement), a process using BDOF (Bi-directional Optical Flow), and a process using PROF (Prediction Refinement with Optical Flow).
